(19) United States
(12) Patent Application Publication
(10) Pub. No.: US 2014/0001381 A1
(43) Pub. Date: Jan. 2, 2014

(54) SYSTEM FOR STORAGE AND TRANSPORT OF URANIUM HEXAFLUORIDE

(71) Applicant: Thomas F. DOUGHERTY, Chagrin Falls, OH (US)

(72) Inventor: Thomas F. DOUGHERTY, Chagrin Falls, OH (US)

(73) Assignee: COLUMBIANA HI TECH LLC, Greensboro, NC (US)

(21) Appl. No.: 13/787,231

(22) Filed: Mar. 6, 2013

Related U.S. Application Data
(60) Provisional application No. 61/607,147, filed on Mar. 6, 2012.
(60) Provisional application No. 61/624,671, filed on Apr. 16, 2012.

(51) Int. Cl. G21F 5/015

(52) U.S. Cl. CPC G21F 5/015
USPC 250/507.1; 53/473

(57) ABSTRACT

An overpack for receiving a steel cylinder, such as a stainless steel cylinder, containing uranium hexafluoride includes a semi-cylindrical top portion having an arcuate main body and opposing first and second semi-circular end members, and includes a semi-cylindrical bottom portion having an arcuate main body and opposing first and second semi-circular end members, with the first end members of the top and bottom portion being aligned, and the second end members of the top and bottom portion being aligned, and the overpack is disposed in a cradle.

### CROSS-REFERENCE TO RELATED APPLICATIONS

This application claims priority to and the benefit of U.S. Provisional Application No. 61/607,147, filed Mar. 6, 2012, and U.S. Provisional Application No. 61/624,671 filed Apr. 16, 2012. The disclosures of which applications are incorporated herein by reference.

### BACKGROUND

Uranium Hexafluoride (UF₆ or “Hex”) is a compound used in the uranium enrichment process. It is used in the nuclear industry to produce nuclear fuel. UF₆ is, however, considered to be hazardous and toxic and is very reactive and corrosive. As such, certain measures are taken to ensure containment of UF₆ during storage, and especially during transport. Typically, UF₆ is stored and transported in cylinders, for example ANSI N14.1 30B or 30C cylinders. Generally, regulations require that these cylinders be placed in protective shipping packages (PSPs), e.g. overpacks, during transportation to protect the cylinders during potential accident conditions. Hypothetical accident conditions include situations where the PSP could be dropped or impacted, subjected to a fire event, immersed in water, or otherwise damaged.

Typically, natural or unenriched UF₆ contains the isotope U₂₃₅ in a weight percent of about 7/10 of one percent. Enriched UF₆ has U₂₃₅ in a weight percentage greater than 7/10 of one percent. The isotope U₂₃₅ emits neutrons and, in the enriched state, which gives enriched UF₆ its radioactive characteristics. The industry standard for the commercial use of enriched UF₆ includes weight percentages extending up to and above five percent. In the enriched state, UF₆ can become critical given certain circumstances, for which the chance of becoming critical increases with the amount and/or concentration of U₂₃₅ present. Moderators can slow the movement of emitted neutrons thereby increasing the possibility of a collision, which can trigger a critical event. Persons skilled in the art refer to the K_{eff} factor, where a K_{eff} greater than 1.0 relates to a condition where the number of neutrons are increasing leading toward a critical event. Conversely for a K_{eff} less than 1.0, neutrons are being absorbed. Water is one such moderator of UF₆. Accordingly, it is important to ensure that UF₆ does not become exposed to water or water based substances. If the storage container valves and plugs become damaged and/or deteriorate, the possibility of contact with water significantly increases, as does the possibility of a critical event.

One factor contributing to a critical event pertains to the amount of U₂₃₅ present within a cylinder. Generally, the amount of any substance that can be stored in a given container is limited by the container's construction, e.g. the dimensions of the cylinder walls. For precautionary reasons, it is common that regulations limit the weight quantity of U₂₃₅ that can be stored in a container to five (5) weight percent of the total volume of material stored in a cylinder. However, in recent years the industry has been desirous of shipping and storing enriched UF₆ containing U₂₃₅ in weight percentages in excess of five (5) percent.

Further, reprocessed uranium includes a high number of nuclides, including, but not limited to, U₂₃₈, and U₂₃₅ and U₂₃₆, and even U₂₃₄, U₂₃₃, and U₂₃₂. Due to this, it is generally desired that any container for the storage of shipment of reprocessed uranium be leak-tight, as understood in the industry. There is currently an inability of uranium enrichers to measure a leak rate below 1×10⁻³ REF-CM³/Sec, using the prior art model.

As such, natural uranium (unenriched or enriched) and reprocessed uranium are not stored or transported in the same systems.

### BRIEF SUMMARY

This pertains to systems for storage and transport of Uranium Hexafluoride.

A system for storage and transport of uranium hexafluoride includes an overpack having a semi-cylindrical top portion including an arcuate main body and having opposing first and second semi-circular end members with a first c-channel disposed in the first end member of the top portion, and a semi-cylindrical bottom portion including an arcuate main body and having opposing first and second semi-circular end members with a second c-channel disposed in the second end member of the bottom portion, where the first end members of the top and bottom portion are aligned and the second end members of the top and bottom portion are aligned. The system also includes a stainless steel cylinder containing uranium hexafluoride disposed within the interior of the overpack.

The cylinder includes a generally tubular stainless steel main body. The cylinder has opposing first and second distal stainless steel end members at opposing distal ends of the main body. A valve is disposed in a port in the first distal end and a plug is disposed in a port in the second distal end. The valve may be aligned with the first c-channel and the plug may be aligned with the second c-channel. The cylinder may include opposing chimed ends extending therefrom toward the first and second c-channels respectively.

The overpack may also include a third c-channel disposed in the second end member of the top portion and a fourth c-channel disposed in the first end member of the bottom portion.

The c-channels may face concave toward the interior of the overpack. The c-channels may be oriented parallel to a diameter edge of the respective end members.

The overpack may further include a first plate disposed on the interior of the first end member of the top portion between the first c-channel and the interior of the overpack and a second plate disposed on the interior of the second end member of the bottom portion between the second c-channel and the interior of the overpack. The overpack may also include a third plate disposed on the interior of the second end member of the top portion between the third c-channel and the interior of the overpack and a fourth plate disposed on the interior of the first end member of the bottom portion between the fourth c-channel and the interior of the overpack.

The overpack may further include a first shielding layer disposed upon the interior of the arcuate main body of the top portion and may include a second shielding layer disposed upon the interior of the arcuate main body of the bottom portion.

The overpack may be disposed in a cradle. The cradle may include a top shell portion including an upper metallic shielding layer and a bottom shell portion including a lower metallic shielding layer, with the top shell portion and the bottom shell portion connected to form a shielded cavity. The upper metallic shielding layer and the lower metallic shielding layer may be comprised of stainless steel. The upper metallic shielding layer and the lower metallic shielding layer may be about one inch thick.

Advantages of the embodiments described below will become apparent to those skilled in the art.

### BRIEF DESCRIPTION OF THE DRAWINGS

FIG. 1 is a perspective view of a system for storage and transport of Uranium Hexafluoride.

FIG. 2 is a perspective view of the system of FIG. 1 with the top of the overpack removed and showing the cylinder therein.

FIG. 3 is a partial cutaway side view of the cylinder shown in FIG. 2.

FIG. 4A is an end view of the first end of the cylinder of FIG. 3.

FIG. 4B is an end view of the second end of the cylinder of FIG. 3

FIG. 5 is a cross-sectional side view of the overpack of FIG. 1.

FIG. 6 is a cross-sectional end view of the overpack of FIG. 1.

FIG. 7 is a side view, partially broken away, of a system for storage and transport of Uranium Hexafluoride according to another embodiment.

FIG. 8 is an end view, partially broken away, of the system of FIG. 7.

### DETAILED DESCRIPTION

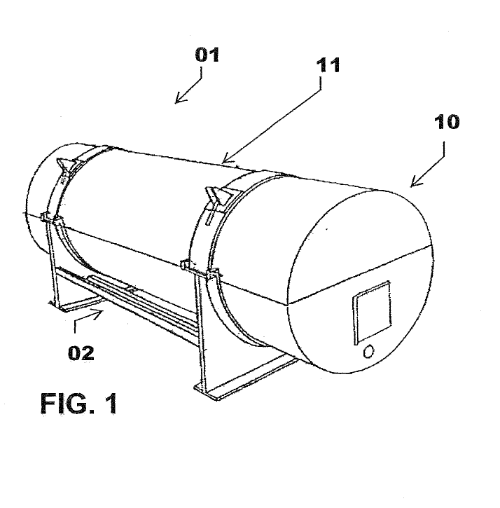

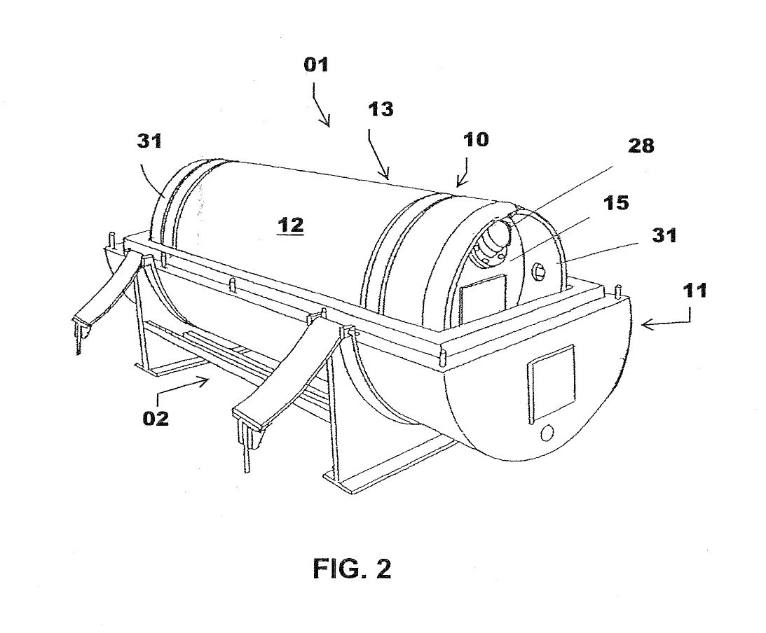

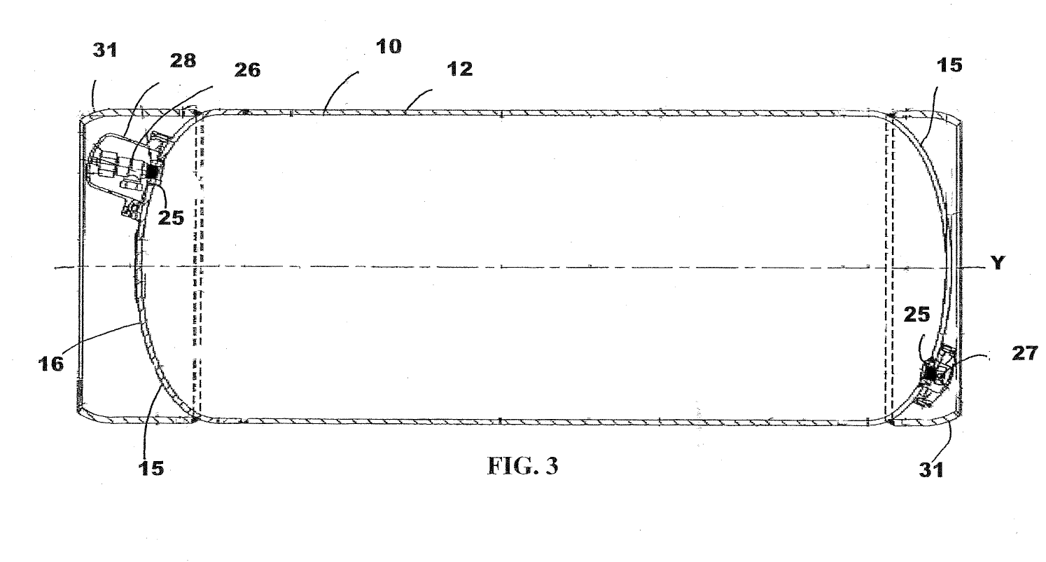

Referring to the drawings, which are illustrative of certain embodiments and not intended to be limiting, there is shown in FIG. 1 a system 01 for storage and transport of uranium hexafluoride. The system 01 includes an overpack 11 disposed in a cradle 02. As best shown in FIG. 2 the system 01 also includes a cylinder 10 disposed in the overpack 11.

The cylinder 10 is constructed to contain hazardous and/or radioactive materials, one example of which includes Uranium Hexafluoride (also termed UF₆). It must be appreciated that regulations may exist which provide certain design or usage constraints for a vessel of this type.

The cylinder 10 and overpack 11 may be of standard size, such as for 30B containers as regulated by governmental agencies. The overpack 11 may function to protect the cylinder 10 from impact or other damage as well as ambient conditions. The overpack 11, and corresponding cylinder 10 filled with hazardous material, such as uranium hexafluoride, may be placed into a cradle 02 for storage or handling during transport.

Referring now to FIG. 2, the cylinder 10 is a generally cylindrical container and includes a generally tubular stainless steel main body 12 along with distally-arranged stainless steel end members 15. It has been discovered that the use of stainless steel in the cylinder 10 containing uranium hexafluoride results in a container with an improved brittle fracture rating as compared to a container made from a non-stainless steel.

The main body 12 and end members 15 define an interior region for storing Uranium Hexafluoride. The main body 12 of the cylinder 10 is symmetrically fashioned around a central, longitudinal axis Y, and has a generally circular cross section, which is particularly suited for storing pressurized Uranium Hexafluoride. The end members 15 are affixed to the main body 12 in a manner suitable for preventing the leakage of the contents of the cylinder 10, even under severe conditions, such as, but not limited to, welding. In one embodiment, the end members 15 are welded to the main body 12 as will be further discussed below.

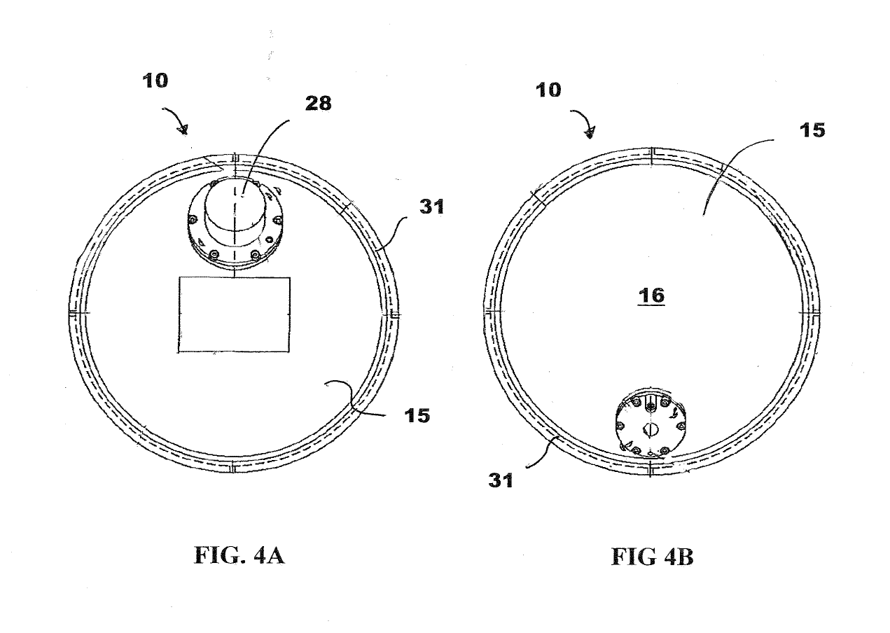

For the addition or subtraction of contained substance, e.g. for filling and emptying the cylinder 10, at least one flow access is included that allows for the ingress and/or egress of Uranium Hexafluoride, along with any suitable desired flow control mechanism. In the illustrative example, ports 25 may be formed into the walls, e.g. the ends 15, of the cylinder 10 for transferring Uranium Hexafluoride into and out of the cylinder 10 as desired. A valve 26, for example, may be provided in one end 15 and a plug 27 may be provided in the other end 15. It is well known in the art that substances like Uranium Hexafluoride react violently with water or water-based substances. Accordingly, the ports 25, along with the valve 26 and the plug 27, may be specifically constructed and installed to withstand damage during use and/or deterioration from exposure to ambient conditions that would allow substances of this nature to intermix. As an additional measure of safety, a valve cap or cover 28, shown in FIG. 4, and assembly for sealing the valve cover 28 may be incorporated.

In the present example, the main body 12 is constructed from sheet steel roll formed into the straight cylindrical configuration. In one embodiment, the sheet steel may have a minimum thickness of 13/32 inch and have a length of substantially 81½ inches long. When roll-formed, the I.D., i.e. inner diameter, may be 29¼ inches. Additionally, the type of steel utilized in constructing the main body 12 aside from a stainless steel, such as ASTM SA Type 304 stainless steel, the steel may be ASME SA-516 Grade 70 carbon steel. However, other grades of steel may be used that conform to the proper regulatory restrictions including, but not limited to, Title 49 of the Code of Federal Regulations. Once the steel body 12 has been formed into a cylinder, the seam 13 may be fused together by welding to join the sides of the main body 12. In one embodiment, the seam 13 may be fusion welded. However, any method of constructing the cylinder 10 may be chosen as is appropriate for use thereon.

The end members 15 may be constructed from the same type of material as that of the main body 12, namely SA-516 Grade 70 carbon steel. However, the thickness of the end members 15 may be thicker than the main body 12. In one embodiment, the thickness is approximately 0.7 inch. A minimum thickness may be 11/16 inch. However, any thickness above the minimum thickness may be chosen with sound judgment as is appropriate for use with the embodiments of the subject invention. The end members 15 may be fashioned in the shape of a disk or plate having an outer diameter corresponding to the inner diameter of the main body 12. The end members 15 may be curved at their respective center portions 16 thereby defining a domed shape with a corresponding radius that extends to a circumferential edge. In one embodiment, the corresponding radius is uniform from a center point to the circumferential edge. It is noted here that the cylinder 10 may include two end members 15, each one disposed on distal ends of the main body 12.

The ends of the cylinder 10 may respectively include chimes 31. Each of the chimes 31 may extend from the main body 12 and/or end members 15 of the cylinder 10. The chimes 31 function to protect the end of the cylinder 10 and more particularly the valves or other components mounted to the end members 15. In this manner, should the cylinder 10 impact the ground or other structure, force from the impact may be translated to the chimes 31 protecting the valves from damage. Of course, it will be readily seen that the first and second chimes 31, are respectively mounted at distal ends of the cylinder 10 for protecting valve 26 and/or plug 27 as may be respectively installed into the end members 15. It is expressly noted that the length of the first and second chimes 31 need not necessarily be equal. That is to say that one chime 31 may be substantially longer than the other chime 31. Any difference in length may be selected that appropriately protects the various components, e.g. valves, plugs and the like, installed into the end members 15. In an exemplary manner, one chime 31 may have a length of substantially 9 inches. The other chime 31 may have a length of substantially 12 inches. It is noted that the respective length of the chimes 31 may vary widely. However, regulatory constraints may be in place that restrict the overall length of the container. Accordingly, any proportional length of the chimes 31 may be chosen that falls within the required guidelines governing the use and construction of the cylinder 10.

As mentioned above, the cylinder 10 may further include a port 25 used to fill the cylinder 10 with the hazardous substance. The port 25 opens to allow substances like Uranium Hexafluoride to enter the cylinder 10 and closes to securely and safely seal the contents inside. To ensure safety, the port 25 may be protected by a valve cover 28, shown in FIG. 4. The valve cover 28 provides an additional barrier to the egress of Uranium Hexafluoride and more critically to the ingress of water into the cylinder 10 through the port 25. The valve cover 28 may be disposed within the chime 31 area, which extends from the domed end of the cylinder 10, as mentioned above. More particularly, the distal end of the valve cover 28 may be recessed by at least 0.5 inch and preferably 0.75 inch or more from a plane defined by the free edge of the chime 31. This space allows for deformation of an over-pack during drop testing, or other impact, without any contact with the valve cover 28. Therefore, the cylinder 10 fitted with the valve cover 28 may be used with standard over-packs as may be required by rules governing the storage and transportation of the hazardous materials.

The cylinder 10, as described above, provides for an improved ability to measure the leak rate, and thus an improved ability determine the leak-tightness, as compared to prior uranium hexafluoride containers. In particular, the cylinder 10 has a measured leak rate of less than 1×10⁻³ REF-CM³/Sec.

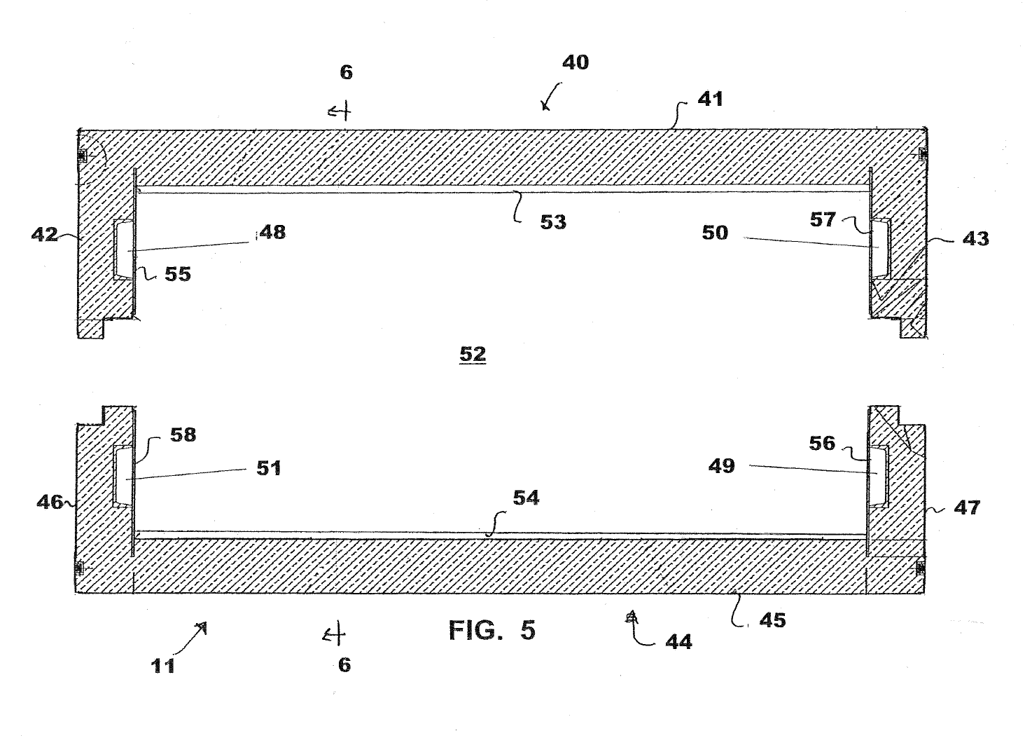

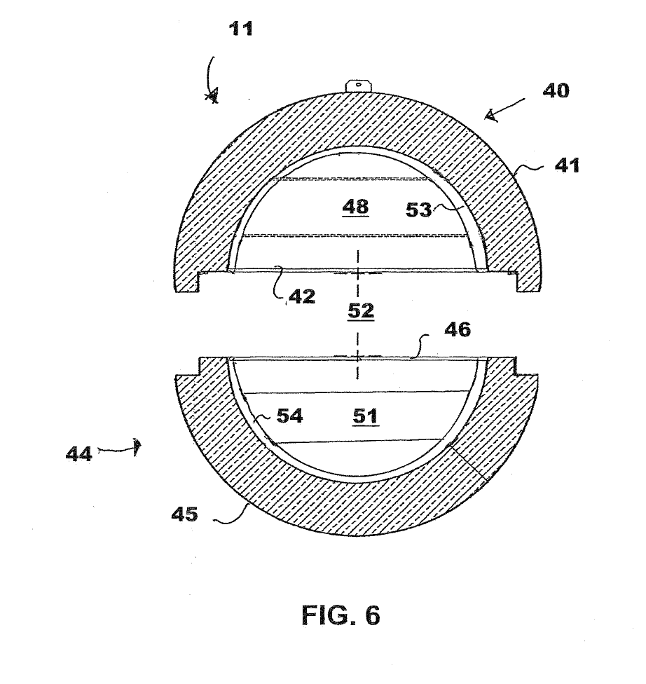

As best shown in FIGS. 5 and 6, the overpack 11 includes a semi-cylindrical top portion 40 including an arcuate main body 41 and having opposing first and second semi-circular end members 42, 43. The overpack 11 also includes a semi-cylindrical bottom portion 44 including an arcuate main body 45 and having opposing first and second semi-circular end members 46, 47. The first end members 42, 46 of the top and bottom portions 40, 44 are aligned and the second end members 43, 47 of the top and bottom portions 40, 44 are aligned.

A first c-channel 48 is disposed in the first end member 42 of the top portion 40. A second c-channel 49 is disposed in the second end member 47 of the bottom portion 44. A third c-channel 50 is disposed in the second end member 43 of the top portion 40. A fourth c-channel 51 is disposed in the first end member 46 of the bottom portion 44.

In the illustrated example, the c-channels 48-51 face concave toward the interior 52 of the overpack 11, although such is not required. In the preset example, the first c-channel 48 and fourth c-channel 51 are opposed, i.e. at opposite ends of the overpack 11, the second c-channel 49 and third c-channel 50. Further, the c-channels 48-51 are optionally shown as being oriented parallel to the diameter edge of the respective end members 42, 43, 46, 47, although such is not required.

A first shielding layer 53 is disposed upon the interior of the arcuate main body 41 of the top portion 40. A second shielding layer 54 is disposed upon the interior of the arcuate main body 45 of the bottom portion 44.

A first plate 55 is disposed on the interior of the first end member 42 of the top portion 40 between the first c-channel 48 and the interior 52 of the overpack 11. A second plate 56 is disposed on the interior of the second end member 47 of the bottom portion 44 between the second c-channel 49 and the interior 52 of the overpack 11. A third plate 57 is disposed on the interior of the second end member 43 of the top portion 40 between the third c-channel 50 and the interior 52 of the overpack 11. A fourth plate 58 is disposed on the interior of the first end member 46 of the bottom portion 44 between the fourth c-channel 51 and the interior 52 of the overpack 11.

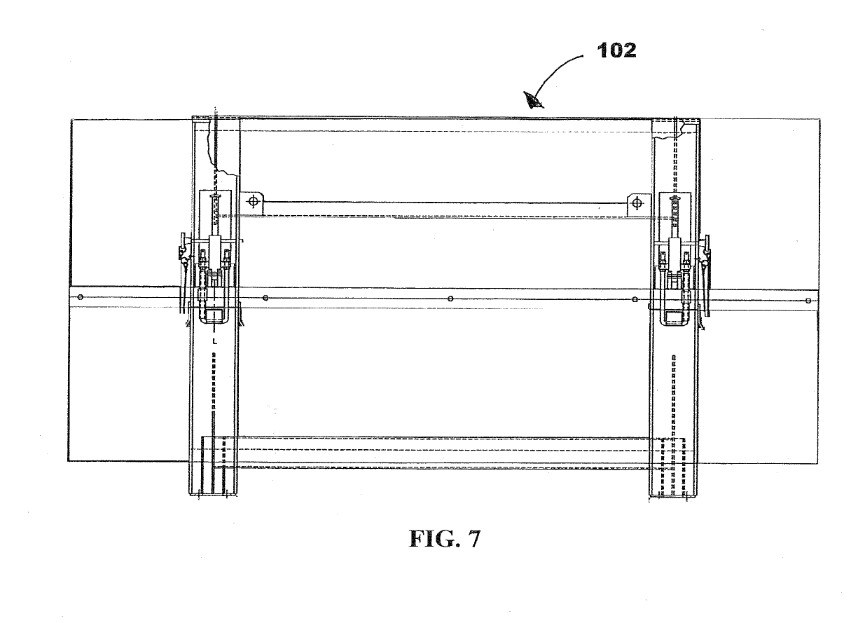

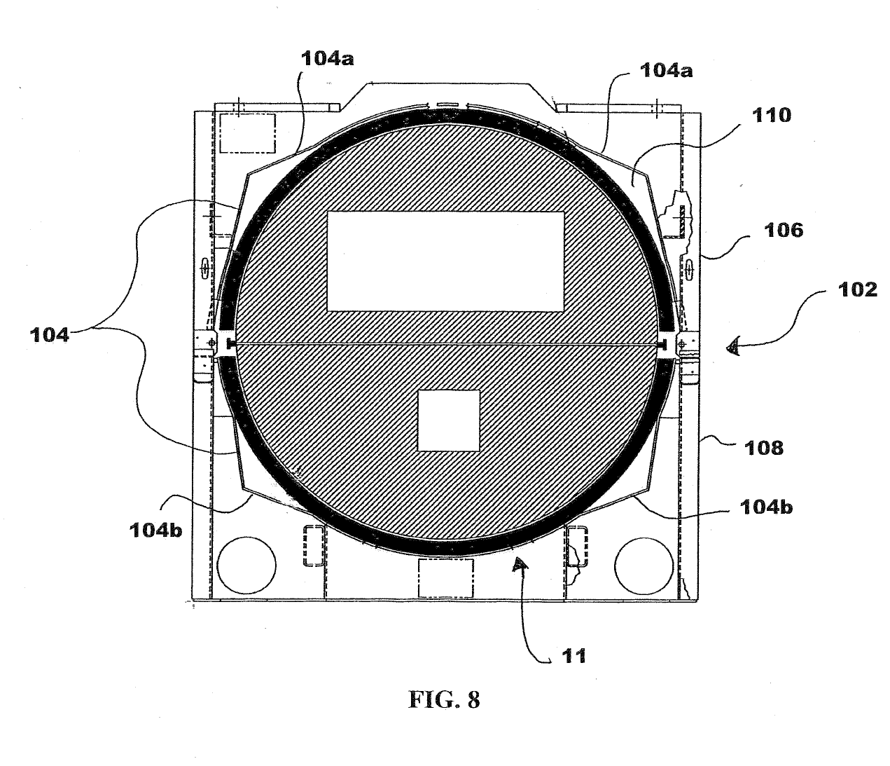

As shown in FIGS. 7 and 8 in another embodiment, the overpack 11 may be disposed in a stackable cradle 102 includng shielding 104. The cradle 102 includes a top shell portion 106 including an upper metallic shielding layer 104a and a bottom shell portion 108 including a lower metallic shielding layer 104b. The top shell portion 106 and the bottom shell portion 108 are connected to form a shielded cavity 110 with the overpack 11 disposed therein.

The shielding 104 is comprised of stainless steel. However, it must be understood that the shielding 104 may be comprised of any material suitable to shield radiation. The upper metallic shielding layer 104a and the lower metallic shielding layer 104b are each about one inch thick. However, it must be understood that the thickness of the upper metallic shielding layer 104a and the lower metallic shielding layer 104b may be other than about one inch thick and that this thickness may be selected depending upon the properties of the material comprising the shielding 104 and desired amount of radiation shielding.

As illustrated, each of the upper metallic shielding layer 104a and the lower metallic shielding layer 104b are each formed into a half shell of approximately 180 degrees, such that when the upper metallic shielding layer 104a and the lower metallic shielding layer 104b are brought together, they form shielding 104 about 360 degrees of the cavity 110. It must be understood, however, that the upper metallic shielding layer 104a and the lower metallic shielding layer 104b may each be extend about any suitable degree of the cavity 110, such that the upper metallic shielding layer 104a and the lower metallic shielding layer 104b combine to provide 360 degrees of shielding in total.

In one exemplary use, when the cylinder 10 containing uranium hexafluoride is placed in the interior 52 of the overpack 11, the valve 26 is aligned with the first c-channel 48 and the plug 27 is aligned with the second c-channel 49. The overpack 11 may then be placed in a support such as the cradle 02 or the shielded cradle 102. It must be understood, however, that it is expected that the cylinder 12 may be placed in the overpack 11 in any orientation.

A system for storage and transport of uranium hexafluoride as described above provides for a uranium hexafluoride storage and transport system that has reduced brittle fracture and improved leak-tightness over prior uranium hexafluoride containers. Additionally, the system has an improved ability to measure leak rate and determine leak-tightness over prior containers. Further, this system provides for the storage and transport of uranium hexafluoride in natural (unenriched or enriched) state or a reprocessed state. Also, the system provides for improved secondary containment over prior art systems.

While description has been made herein with reference to certain embodiments, it must be understood that modifications and alterations will occur to others upon a reading and understanding of this description. It is intended to include all such modifications and alterations insofar as they come within the scope of the appended claims or the equivalence thereof.

What is claimed is:

1. A system for storage and transport of uranium hexafluoride comprising:
an overpack including:
a semi-cylindrical top portion including an arcuate main body and having opposing first and second semi-circular end members with a first c-channel disposed in the first end member of the top portion, and
a semi-cylindrical bottom portion including an arcuate main body and having opposing first and second semi-circular end members with a second c-channel disposed in the second end member of the bottom portion,
where the first end members of the top and bottom portion are aligned and the second end members of the top and bottom portion are aligned, and
a cylinder containing uranium hexafluoride disposed within the interior if the overpack, the cylinder including a generally tubular stainless steel main body.

2. The system of claim 1 where the cylinder has first and second carbon steel or stainless steel end members at opposing distal ends of the main body with a valve disposed in a port in the first distal end and a plug disposed in a port in the second distal end where the valve is aligned with the first c-channel and the plug is aligned with the second c-channel.

3. The system of claim 2 where a third c-channels is disposed in the second end member of the top portion and where a fourth c-channel is disposed in the first end member of the bottom portion.

4. The system of claim 1 where the first and second c-channels face concave toward the interior of the overpack.

5. The system of claim 1 where the overpack further includes a first shielding layer disposed upon the interior of the arcuate main body of one of the top portion or the bottom portion and includes a second shielding layer disposed upon the interior of the arcuate main body of the other of the top portion or the bottom portion.

6. The system of claim 1 where the overpack further includes a first plate disposed on the interior of the first end member of the top portion between the first c-channel and the interior of the overpack and a second a plate disposed on the interior of the second end member of the bottom portion between the second c-channel and the interior of the overpack.

7. The system of claim 1 where the first c-channel is oriented parallel to a diameter edge of the first end member of the top portion and where the second c-channel is oriented parallel to a diameter edge of the second end member of the bottom portion.

8. The system of claim 1 where the cylinder includes opposing chimed ends extending therefrom toward the first and second c-channels respectively.

9. An overpack for receiving a cylinder containing uranium hexafluoride comprising:
a semi-cylindrical top portion including an arcuate main body and having opposing first and second semi-circular end members, and
a semi-cylindrical bottom portion including an arcuate main body and having opposing first and second semi-circular end members,
where the first end members of the top and bottom portion are aligned and the second end members of the top and bottom portion are aligned and where a first c-channel is disposed in one of the end members.

10. The overpack of claim 9 where the first c-channel is disposed in the first end member of the top portion and where a second c-channel is disposed in the second end member of the bottom portion opposite the first c-channel.

11. The overpack of claim 10 where a third c-channel is disposed in the second end member of the top portion and where a fourth c-channel is disposed in the first end member of the bottom portion.

12. The overpack of claim 10 where the first and second c-channels face concave toward the interior of the overpack.

13. The overpack of claim 10 further comprising a first shielding layer disposed upon the interior of the arcuate main body of one of the top portion or the bottom portion.

14. The overpack of claim 13 further comprising a second shielding layer disposed upon the interior of the arcuate main body of the other of the top portion or the bottom portion.

15. The overpack of claim 10 further comprising a plate disposed on the interior of the first end member of the top portion between the first c-channel and the interior of the overpack.

16. The overpack of claim 10 further comprising a plate disposed on the interior of the second end member of the bottom portion between the second c-channel and the interior of the overpack.

17. The overpack of claim 10 where the first c-channel is oriented parallel to a diameter edge of the first end member of the top portion.

18. The overpack of claim 10 where the second c-channel is oriented parallel to a diameter edge of the second end member of the bottom portion.

19. A method of placing a stainless steel cylinder containing uranium hexafluoride in an overpack comprising:
a. providing an overpack having a semi-cylindrical top portion including an arcuate main body and having opposing first and second semi-circular end members with a first c-channel disposed in the first end member of the top portion, and a semi-cylindrical bottom portion including an arcuate main body and having opposing first and second semi-circular end members with a second c-channel disposed in the second end member of the bottom portion, where the first end members of the top and bottom portion are aligned and the second end members of the top and bottom portion are aligned;
b. providing a stainless steel cylinder containing uranium hexafluoride; and
c. placing the stainless steel cylinder within the interior of the overpack.

20. The method of claim 19 where the cylinder has opposing first and second distal ends with a valve disposed in a port in the first distal end and a plug disposed in a port in the second distal end, and the method further comprising:
d. aligning the valve with the first c-channel and the plug with the second c-channel.

21. A system for storage and transport of uranium hexafluoride comprising:
an overpack including:
a semi-cylindrical top portion including an arcuate main body and having opposing first and second semi-circular end members, and
a semi-cylindrical bottom portion including an arcuate main body and having opposing first and second semi-circular end members,
where the first end members of the top and bottom portion are aligned and the second end members of the top and bottom portion are aligned, and
a cylinder containing uranium hexafluoride disposed within the interior if the overpack, the cylinder including a generally tubular stainless steel main body.

22. The system of claim 21 where the cylinder has first and second carbon steel or stainless steel end members at opposing distal ends of the main body with a valve disposed in a port in the first distal end and a plug disposed in a port in the second distal end where the valve is aligned with the first c-channel and the plug is aligned with the second c-channel.

23. The system of claim 21 where the cylinder has a measured leak rates less than 1×10⁻³ REF-CM³/Sec.

24. A system for storage and transport of uranium hexafluoride comprising:
a cradle including:
a top shell portion including an upper metallic shielding layer, and
a bottom shell portion including a lower metallic shielding layer,
where the top shell portion and the bottom shell portion are connected to form a shielded cavity,
an overpack disposed in the shielded cavity of the cradle including:
a semi-cylindrical top portion including an arcuate main body and having opposing first and second semi-circular end members, and
a semi-cylindrical bottom portion including an arcuate main body and having opposing first and second semi-circular end members,
where the first end members of the top and bottom portion are aligned and the second end members of the top and bottom portion are aligned, and
a cylinder containing uranium hexafluoride disposed within the interior of the overpack, the cylinder including a generally tubular steel main body.

25. The system of claim 24 where the upper metallic shielding layer and the lower metallic shielding layer are comprised of stainless steel.

26. The system of claim 24 where the upper metallic shielding layer and the lower metallic shielding layer are about one inch thick.

27. A method of placing a stainless steel cylinder containing uranium hexafluoride in an overpack and cradle comprising:
a. providing an overpack having a semi-cylindrical top portion including an arcuate main body and having opposing first and second semi-circular end members and a semi-cylindrical bottom portion including an arcuate main body and having opposing first and second semi-circular end members, where the first end members of the top and bottom portion are aligned and the second end members of the top and bottom portion are aligned;
b. providing a stainless steel cylinder containing uranium hexafluoride;
c. placing the stainless steel cylinder within the interior of the overpack;
d. providing a cradle having a top shell portion including an upper metallic shielding layer, and a bottom shell portion including a lower metallic shielding layer, where the top shell portion and the bottom shell portion are connected to form a shielded cavity; and
e. placing the overpack within the shielded cavity of the cradle.

28. The method of claim 27 where the upper metallic shielding layer and the lower metallic shielding layer are comprised of stainless steel.

29. The method of claim 27 where the upper metallic shielding layer and the lower metallic shielding layer are about one inch thick.
